(19) United States
(12) Patent Application Publication
(10) Pub. No.: US 2025/0030506 A1
(43) Pub. Date: Jan. 23, 2025

(54) METHODS AND PROCEDURES FOR PREDICTIVE EARLY HARQ

(71) Applicant: INTERDIGITAL PATENT HOLDINGS, INC., Wilmington, DE (US)

(72) Inventors: Ahmet Serdar Tan, London (GB); Onur Sahin, London (GB); Mihaela Beluri, Jericho, NY (US); Arnab Roy, Phoenixville, PA (US); Mohamed Salah Ibrahim, Chesterbrook, PA (US)

(73) Assignee: INTERDIGITAL PATENT HOLDINGS, INC., Wilmington, DE (US)

(21) Appl. No.: 18/707,469

(22) PCT Filed: Nov. 7, 2022
(86) PCT No.: PCT/US2022/049133

§ 371 Date: May 3, 2024

Related U.S. Application Data
(60) Provisional application No. 63/410,024, filed on Sep. 26, 2022.
(60) Provisional application No. 63/276,327, filed on Nov. 5, 2021.

(51) Int. Cl. H04L 1/1829; H04L 1/1812

(52) U.S. Cl. CPC H04L 1/1854; H04L 1/1812

(57) ABSTRACT

In an embodiment, a wireless transmit-receive unit includes a receiver, a processor, and a transmitter. The receiver is configured to receive, from a base station, an encoded code block of a transport block. The processor is configured to predict whether the processor will decode the encoded code block successfully. And the transmitter is configured to transmit, to the base station, a result of the predicting.

### CROSS-REFERENCE TO RELATED APPLICATIONS

This application claims the benefit of U.S. Provisional Application No. 63/276,327, filed Nov. 5, 2021, and U.S. Provisional Application No. 63/410,024, filed Sep. 26, 2022, the contents of which are incorporated herein by reference.

### SUMMARY

A method performed by a wireless transmit-receive unit (WTRU) may comprise transmitting an indication of an early hybrid automatic repeat request (E-HARQ) capability in a physical (PHY) parameter information element of a capability message. The method may further comprise receiving an E-HARQ timing indicator and a HARQ timing indicator, receiving one or more reference symbols (RSs) and an encoded code block (RV block) of a transport block (TB) and associating a RS with the TB, wherein the RS is used for channel estimation of the corresponding symbols of the RV block of the TB. A transmission reliability score (TRS) may be computed and a channel decoder success may be predicted for the received encoded code block (RV block) of the TB. The WTRU may send early acknowledgement (eACK) or early negative acknowledgement (eNACK) feedback and/or TRS feedback to a base station (BS) based on the channel decoder success prediction. The forward error correction (FEC) decoding may be completed and, based on a cyclic redundancy check (CRC) result after decoding, an ACK or a NACK may be sent to the BS. On a condition a NACK is sent to the BS, the WTRU may receive a next encoded code block and process an RV block depending on the TRS. On a condition an ACK is sent to the BS, the WTRU may start to process the next transport block.

In an embodiment, a wireless transmit-receive unit includes a receiver, a processor, and a transmitter. The receiver is configured to receive, from a base station, an encoded code block of a transport block. The processor is configured to predict whether the processor will decode the encoded code block successfully. And the transmitter is configured to transmit, to the base station, a result of the predicting.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a timing diagram illustrating Round Trip Time (RTT) Components, according to an embodiment;

FIG. 3 is a timing diagram illustrating RTT in Predictive hybrid automatic repeat request (HARQ), according to an embodiment;

FIG. 4 is a diagram illustrating reactive, proactive, and predictive HARQ under same delay budget, according to an embodiment;

FIG. 5 is a diagram illustrating proposed blocks in the physical (PHY) layer architecture, according to an embodiment;

FIG. 6 is a diagram illustrating transport blocks and reference signals in orthogonal frequency division multiple access (OFDMA), according to an embodiment;

FIG. 7 is a diagram illustrating transmission reliability score (TRS) computation and a channel decoder success predictor, according to an embodiment;

FIG. 8 is a diagram illustrating a latency gain with E-HARQ, according to an embodiment;

FIG. 9 is a flowchart illustrating E-HARQ operation at a wireless transmit/receive unit (WTRU), according to an embodiment;

FIG. 10 is a flowchart illustrating E-HARQ Operation at a BS, according to an embodiment;

FIG. 11 is an illustration of Code Block Allocation and Reference Signals for High Frequency/Bandwidth scenarios, according to an embodiment.

### DETAILED DESCRIPTION

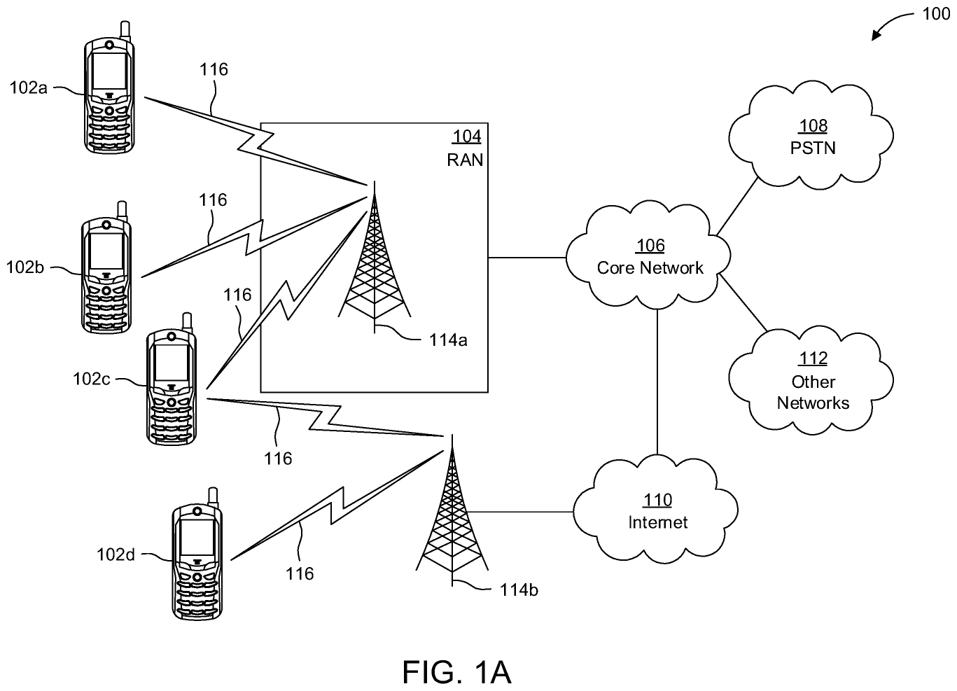

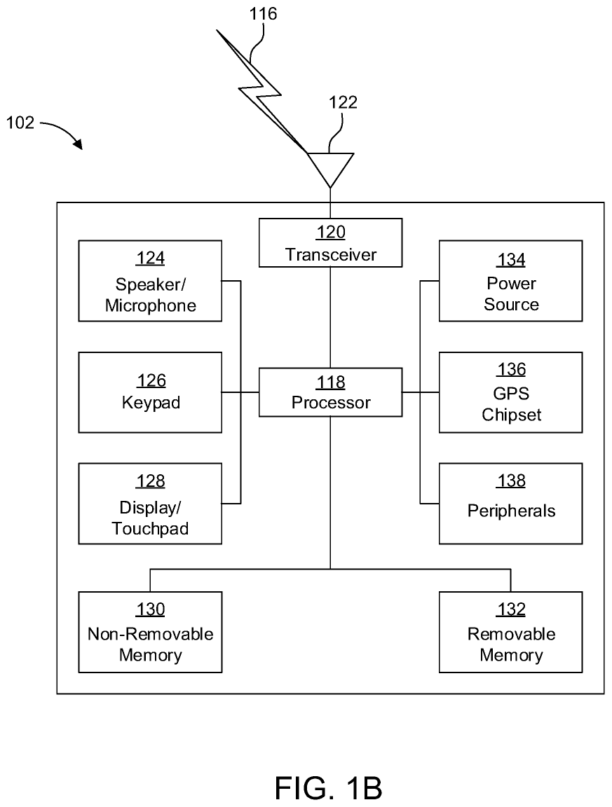

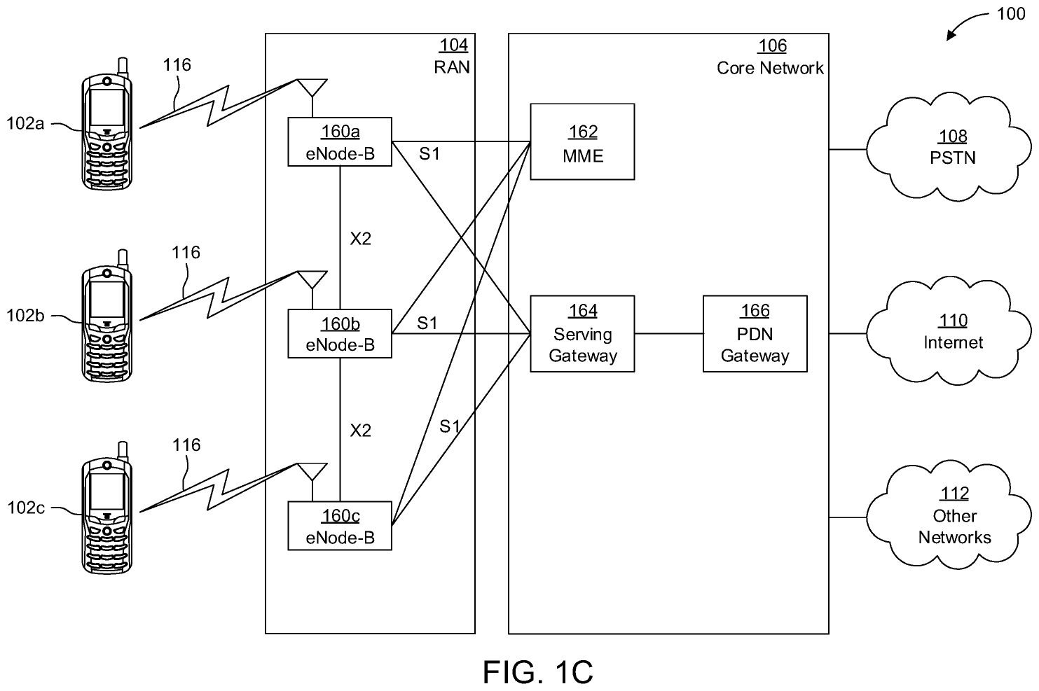

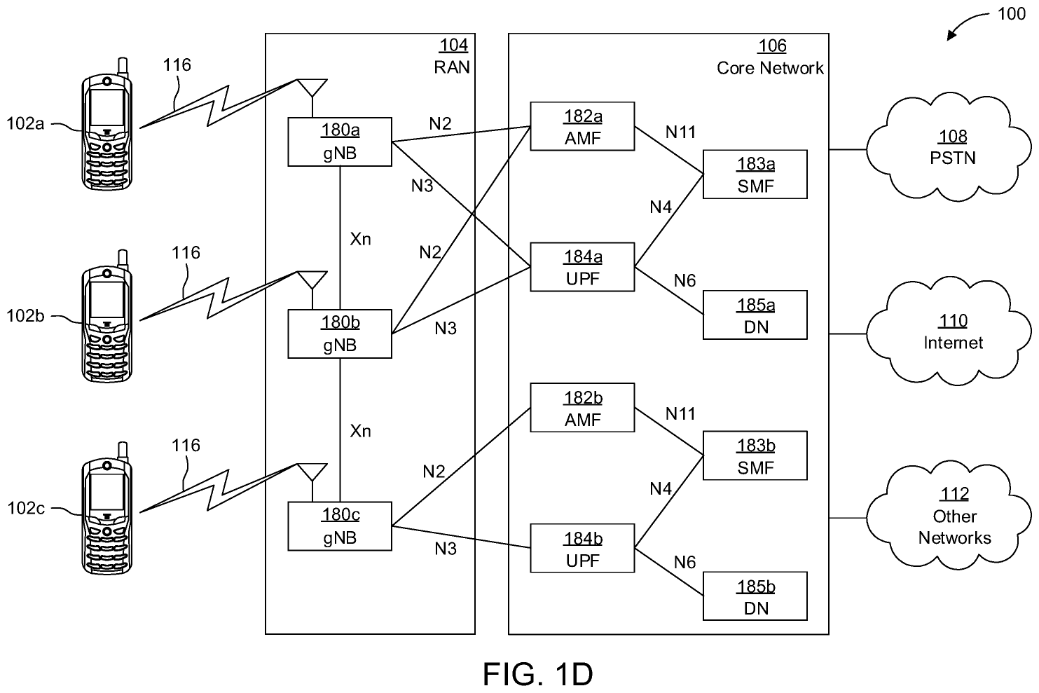

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth®module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In traditional Automatic Repeat Request (ARQ), the packets are retransmitted when the receiver cannot recover the original information. ARQ systems use ACK/NACK feedback messages to notify the transmitter regarding the status of message recovery at the receiver. Hybrid-ARQ (HARQ) is a method that allows retransmissions to be combined at the receiver to increase the decoding performance. Retransmissions are generated and indexed with a Redundancy Version (RV) in HARQ systems. Each RV index may indicate a different number of parity/information bits in a transmission depending on the retransmission number. Traditional HARQ methods that stop and wait for ACK/NACK feedback are named reactive HARQ.

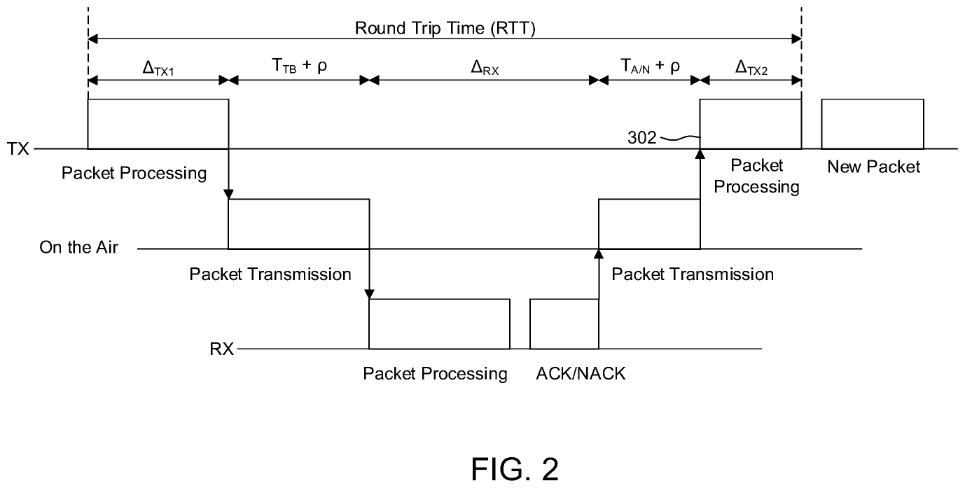

FIG. 2 is a timing diagram illustrating Round Trip Time (RTT) Components.

Round Trip Time is a measure of end-to-end PHY layer latency in systems with retransmission. RTT has several components as shown in FIG. 2.

Δ_{TX1}+Δ_{TX2}: refers to a processing time at a BS, where Δ_{TX1} is the time the BS takes to prepare the transport block (TB) for transmission to the WTRU (RX in FIG. 2) and Δ_{TX2} is the time the BS takes to process the received ACK/NACK. T_{TB}: refers to a transmission duration of a transport block (TB) from the BS to the WTRU, the time to transmit transport block bits until the least significant bit. ρ: refers to a propagation delay. Δ_{RX} refers to a processing time related to the transport block at the WTRU, the time to decode and recover the transport block bits and to prepare ACK/NACK. T_{A/N}: refers to a transmission duration of ACK/NACK information.

Proactive HARQ is a HARQ method that enables uninterrupted new RV transmissions until an ACK is received at the transmitter (TX). In Proactive HARQ, as opposed to reactive HARQ, the TX does not wait for an ACK/NACK before sending retransmission packets to the receiver (RX). The TX sends new RV packets consecutively until ACK feedback is received from the RX.

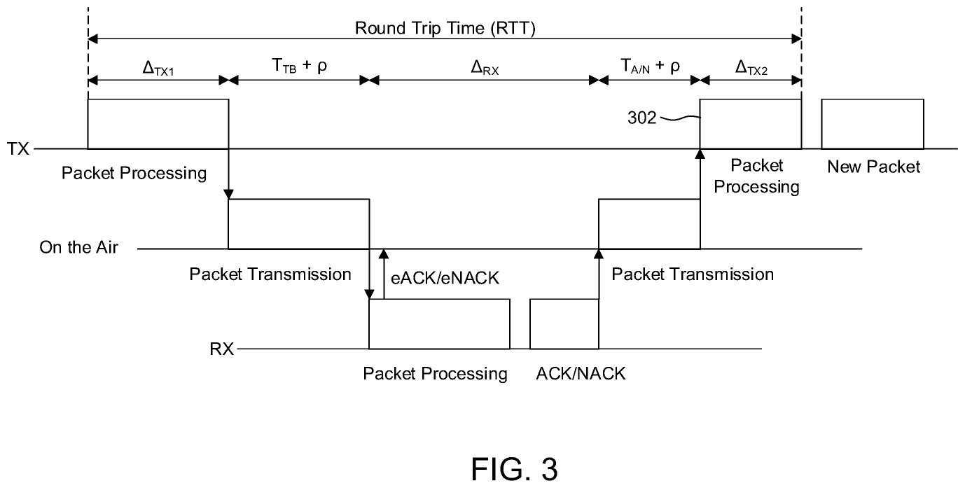

FIG. 3 is a timing diagram illustrating RTT in Predictive, or Early, hybrid automatic repeat request (E-HARQ), according to an embodiment.

Predictive or Early HARQ is another new method where the RX (e.g., a WTRU) predicts the outcome of the decoding process and the CRC check, and sends an early ACK/NACK (eACK/eNACK) feedback message to the TX. An example of eACK/eNACK feedback message is illustrated in FIG. 3 where the eACK/eNACK is sent before the ACK/NACK feedback message. If the WTRU sends eACK, then the BS can commence processing then next TB early, in response to eACK. Therefore, sending eACK can reduce the RTT by the time between when eACK is sent and when ACK/NACK is, or would be, sent. In more detail, sending eACK reduces Δ_{TX2}, possibly to zero, because the BS can begin the packet-processing 302 step in FIG. 3 sooner. If the WTRU subsequently sends ACK, then because the BS already has commenced processing the next TB, the BS can transmit the next TB sooner than the BS otherwise would have been able had the WTRU transmitted only ACK. And if the WTRU sends eNACK, then the BS can commence processing the current TB for retransmission early, in response to eNACK. Therefore, sending eNACK can reduce RTT by the time between when eNACK is sent and the ACK/NACK is, or would be, sent. In more detail, sending eNACK can reduce Δ_{TX2}, possibly to zero, because the BS can begin the packet-processing step 302 sooner. If the WTRU subsequently sends NACK, then, because the BS already has commenced processing of the current TB for retransmission, the BS can retransmit the current TB sooner than the BS otherwise would have been able to had the WTRU transmitted only NACK. And if the WTRU sends eACK but then NACK, or sends eNACK but then ACK, the RTT is no longer than it would have been had the WTRU not used Predictive HARQ (E-HARQ).

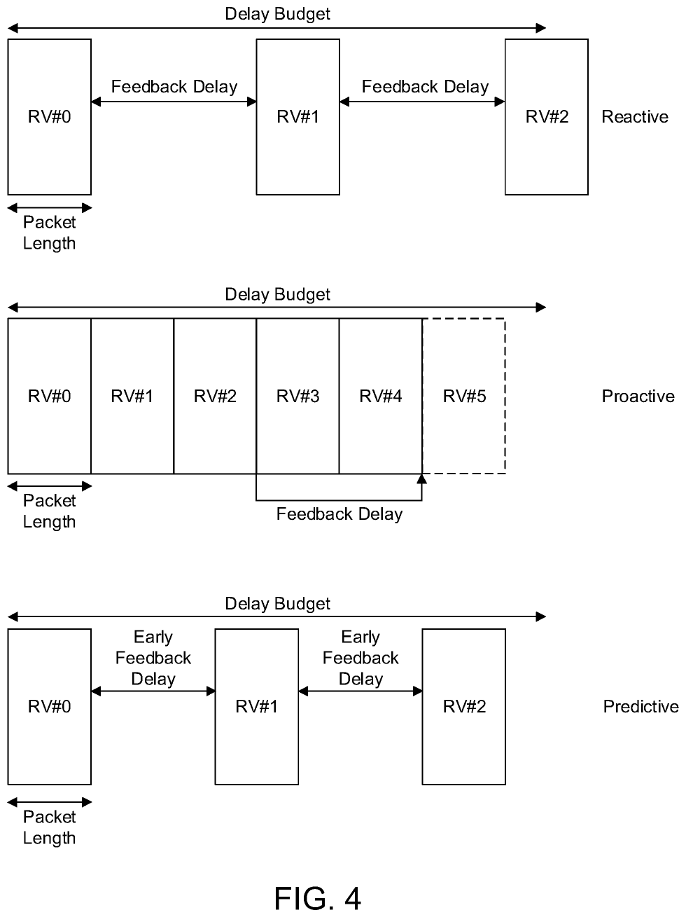

FIG. 4 is a diagram illustrating reactive, proactive, and predictive HARQ under a same delay budget, according to an embodiment.

A comparison of the reactive, proactive and predictive packet transmissions is provided in FIG. 4. In the illustration, all three schemes have the same delay budget. Reactive HARQ has the highest latency. Proactive HARQ may show the lowest latency but it causes redundant retransmissions (RV #3 and RV #4). Predictive HARQ reduces the latency and brings a balanced solution in between reactive and proactive schemes.

Acknowledgement and retransmission of data packets are essential for reliable transmission. Retransmission brings considerable latency based on the round trip time (RTT) of a transport block. RTT is comprised of several components out of which channel decoding procedures consume a significant portion of processing time at the WTRU. Especially in cases with high SCS and data rate, WTRU processing time may become the dominant factor for the end-to-end latency. Measures to improve the WTRU processing time are key to reduce the end-to-end latency in future communication systems.

The ACK/NACK feedback in HARQ is coupled with channel decoding and transport block error detection processes. The two common HARQ schemes are reactive and proactive. Reactive HARQ methods are based on stop and wait mechanism that results in high feedback delay. Proactive HARQ methods rely on continuous retransmission of packets that significantly reduces the throughput. Predictive HARQ is a recent HARQ scheme that relies on the early prediction of ACK/NACK messages (eACK/eNACK) before the channel decoding process is completed. Predictive HARQ is a balanced scheme in between Reactive and Proactive schemes. However, enabling methods and signalling for early HARQ mechanisms are currently missing in the communication systems.

Machine learning methods may be used to predict the outcome of channel decoder in advance. New mechanisms are needed to obtain and deliver the PHY layer information/signals to the prediction block.

A predictive early HARQ feedback and transmission reliability score may be based on reference signals. Systems and methods for predictive early HARQ ACK/NACK feedback using a channel decoder outcome prediction and transmission reliability score at a WTRU, based on reference signals, may include the following steps: the WTRU reports its E-HARQ capability in the PHY-Parameters of UE capability; the WTRU receives the E-HARQ timing indicator in addition to HARQ timing indicator; the WTRU receives Reference Symbols (RS) and the encoded code block (RV block) of a transport block; the WTRU associates the RS to transport block (TB) that are used for channel estimation of the corresponding symbols of the RV block of the transport block; the WTRU computes the transmission reliability score (TRS) and predicts the channel decoder success for the received encoded code block (RV block) of transport block; the WTRU sends eACK or eNACK feedback and/or TRS feedback to a BS based on the channel decoder success prediction; the WTRU completes the FEC decoding and based on the CRC result after decoding, the WTRU sends an ACK or NACK to the BS.

In case WTRU sends a NACK to the BS, the WTRU receives a next encoded code block (new RV block) and processes the RV block depending on TRS. In case the WTRU sends an ACK to the BS, the WTRU starts to process the next transport block.

In an embodiment, methods and procedures that enable an early HARQ (E-HARQ) mechanism at the WTRU for future wireless systems are disclosed. The E-HARQ mechanism is comprised of a channel decoder success predictor and early ACK/NACK (eACK/eNACK) signals accompanied with a reliability score of the transport block.

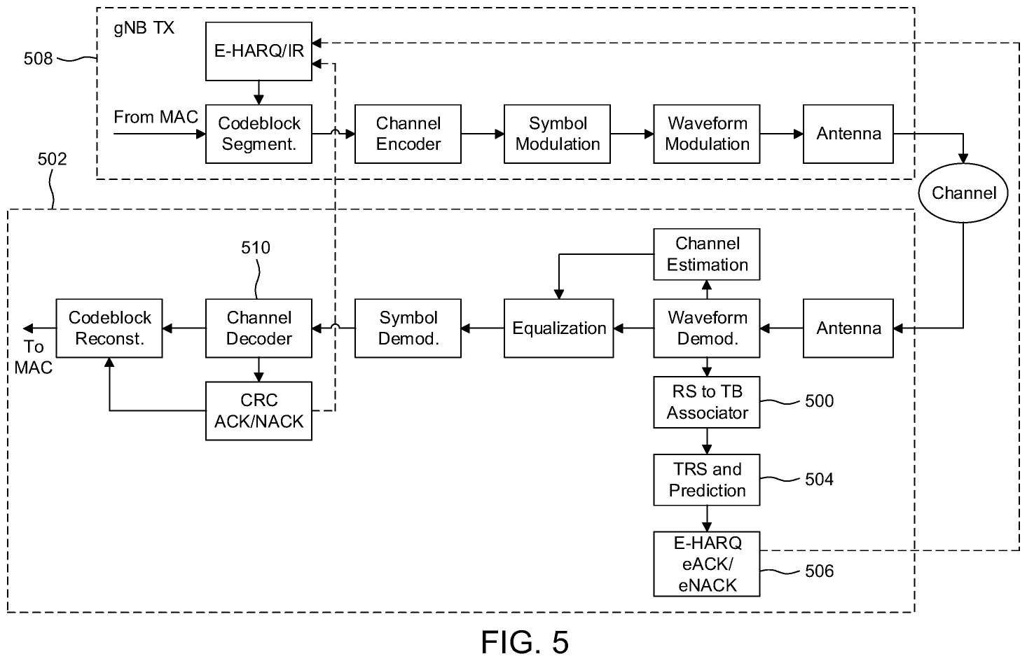

FIG. 5 is a diagram illustrating component blocks in the physical (PHY) layer architecture, according to an embodiment. The functions and operations performed by one or more of the component blocks of the WTRU 502 can be performed by one or more processors such as the processor 118 of FIG. 1. And the functions and operations performed by one or more of the component blocks of the BS 508 can be performed by one or more processors.

New and modified blocks for proposed methods on the PHY layer architecture are shown in FIG. 5 with bold blocks. A reference signal (RS) to transport/code block (TB) associator block 500 at the WTRU 502 may be responsible for the identification of reference signals that are used for the channel estimation of symbols related to the transport block (TB) of interest. A TRS and Prediction block 504 at the WTRU 502 may be responsible for the computation of TRS and prediction of channel decoding success of the received encoded code blocks (RV blocks) of a TB. TRS is a measure of the level of channel distortion specific to the received RV blocks. The E-HARQ eACK/eNACK block 506 at the WTRU 502 may be responsible for the generation of the Early ACK/NACK feedback message to a BS 508 based on the prediction of channel decoding success. The eACK/eNACK feedback message may also include the TRS. The E-HARQ/IR block 506 at the BS 508 may be responsible for the retransmissions based on the eACK/eNACK and ACK/NACK feedback received from the WTRU 502. The block 506 is also responsible for the selection of the size of the retransmission packet, as part of the incremental redundancy (IR) scheme.

A WTRU 502 may have a capability based on Early HARQ methods and circuitry. Each WTRU 502 reports its Early HARQ capability to the BS 508 as a new field in PHY-Parameters of WTRU radio access capability parameters (TS 38.306-4.2.7.10). If the WTRU 502 has E-HARQ capability the WTRU may be configured by the gNB 508 to report both E-HARQ and HARQ. As an example, the new Early HARQ capability field may be included in the PHY-Parameters as the following new 1 bit field: EarlyHARQ-ACK which Indicates whether the WTRU 502 supports an Early HARQ ACK/NACK feedback message.

The WTRU 502 may receive an E-HARQ timing indicator from the BS 508 to schedule its E-HARQ ACK/NACK feedback transmission. The WTRU may receive the new timing indicator for E-HARQ in the downlink control information (DCI) (TS 38.212-7.3.1) (Format 10 or 1_1). As an example the new DCI field may be included as the following field: PDSCH-to-EHARQ_feedback timing indicator. The field may have less than or equal to the number of bits of PDSCH-to-HARQ_feedback timing indicator. The PDSCH-to-EHARQ_feedback timing indicator may indicate the number of slots between PDSCH reception and E-HARQ transmission.

The E-HARQ timing indicator values, from 1 to 8, should be less than the HARQ timing indicator value to ensure that E-HARQ feedback is scheduled before the regular HARQ feedback.

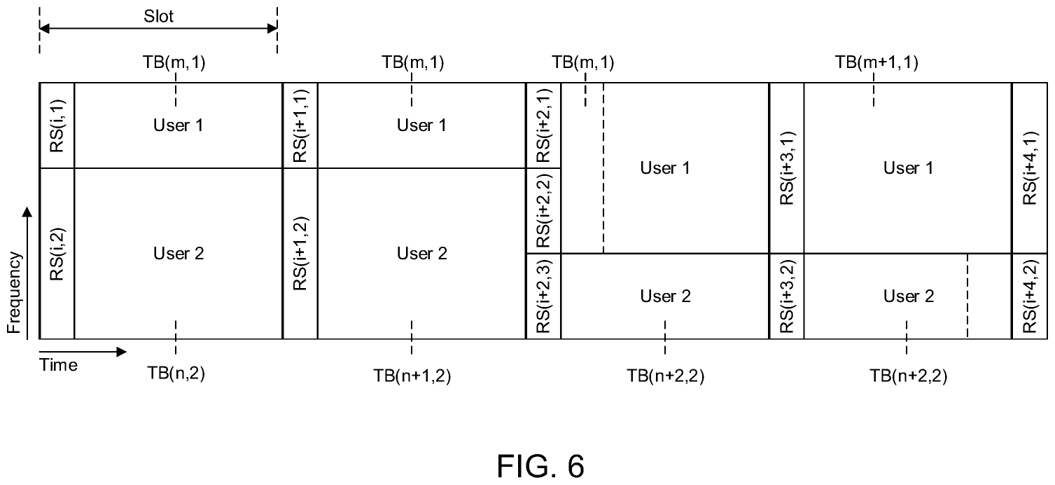

FIG. 6 is a diagram illustrating transport blocks and reference signals in orthogonal frequency division multiple access (OFDMA).

A Reference Signal to Transport Block Association may be configured. An RV block corresponding to Transport/Code Blocks (or code block groups—CBG) may occupy a varying number of symbols depending on symbol modulation and transport block length. Hence, the group of reference signals (RS) that may be used to predict the channel distortion level may also vary in size. In FIG. 6, an example time-frequency resource allocation is illustrated for 2 users, where RS and TB denotes the time-frequency regions for the symbols of reference signals and RV blocks for transport blocks, respectively. In this example reference signals located at the beginning of each slot, e.g., front loaded. The RS to TB Associator 500 (FIG. 5) is used to associate relevant RS to symbols of RV blocks according to one of the options below.

In one option, the associator 500 (FIG. 5) selects the RSs to the left of the symbols that constitute the parity symbols relevant to TB. As an example, with this option, in FIG. 6, [RS(i,2)] is associated with TB(n,2). This option may be used for lower latency requirements.

In another option, the associator 500 (FIG. 5) selects the RSs to the left and right of the symbols that constitute the RV blocks of a TB. As an example, with this option, in FIG. 6, [RS(i,2), RS(i+1,2)] is associated to TB(n,2). This option may be used for higher prediction-accuracy requirements.

For the example in FIG. 6, all associations for both options are given in Table 1. The selected RS will be used to compute the reliability score of the received bits relevant to the TB and predict the channel decoder success.

TABLE 1
Channel Decoder Success Predictor and Transmission Reliability Score Computation

| TB | Selected RS/Option-1 | Selected RS/Option-2 |
|---|---|---|
| TB(m, 1) | RS(i, 1), RS(i + 1, 1), RS(i + 2, 1), | RS(i, 1), RS(i + 1, 1), RS(i + 2, 1), |
| | RS(i + 2, 2) | RS(i + 2, 2), RS(i + 3, 1) |
| TB(m + 1, 1) | RS(i + 3, 1) | RS(i + 3, 1), RS(i + 4, 1) |
| TB(n, 2) | RS(i, 2) | RS(i, 2), RS(i + 1, 2) |
| TB(n + 1, 2) | RS(i + 1, 2) | RS(i + 1, 2), RS(i + 2, 3), RS(i + 2, 2) |
| TB(n + 2, 2) | RS(i + 2, 3), RS(i + 3, 2) | RS(i + 2, 3), RS(i + 3, 2), RS(i + 4, 2) |

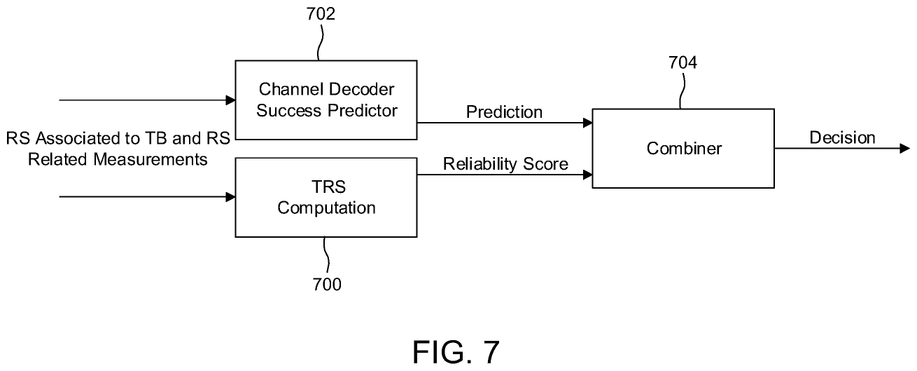

The Transmission Reliability Score (TRS) computation and channel decoder success predictor blocks 700 and 702 are given in FIG. 7. The TRS provides information on the channel distortion based on the reference signals that are associated to the TB and/or other reference signals related measurements (e.g., CSI-RSRP, CSI-RSRQ, CSI-SINR). The score may be computed based on a function that measures the relation between transmitted RS and received RS. Let P_{TB} and \hat{P}_{TB} denote the set of transmitted and received RS that are associated to the TB. Then the TRS may be computed as:

$$T R S = D ( \hat{H} {P}_{T B} , {\hat{P}}_{T B} )$$

where D(X, Y) is a function that measures the relation between arrays of complex vectors X=[x₁, . . . xₙ] and Y=[y₁, . . . , yₙ], and Ĥ denotes the estimated channel response matrix. As an example, to measure the distance between vectors, the distance function D may be calculates as:

$$D = \frac{1}{n} \sqrt{( X - Y ) {( X - Y )}^{H}} .$$

In another example, the normalized distance between the vectors may be used. If the normalized distance between the vectors (e.g. between the Ĥ P_{TB} and \hat{P}_{TB} vectors) exceeds a threshold (e.g. a pre-configured threshold), the TRS score may be low; if the normalized distance is below a threshold (e.g. a pre-configured threshold), the TRS score may be high.

As another example, to measure the correlation between vectors,

$$D = \frac{cov ( X , Y )}{{σ}_{x} {σ}_{Y}} ,$$

where cov(X, Y) and ox denote the sample covariance and standard deviation. The WTRU 502 (FIG. 5) may compute the TRS as a function of the phase noise; for example, the WTRU may estimate the CPE (common phase estimate) based on the received phase tracking reference symbols (PT-RS), and may set a low TRS score if the CPE exceeds a threshold, or a high TRS score when the CPE is below a threshold.

FIG. 7 is a diagram illustrating transmission reliability score (TRS) computator 700, a channel decoder success predictor 702, and a combiner 704, according to an embodiment. The functions and operations of one or more of the computator 700, predictor 702, and combiner 704 can be performed by a processor of a WTRU such as the processor 118 of the WTRU 102 of FIG. 1.

The Channel Decoder Success Predictor block 702, given in FIG. 7, uses the selected RS to predict the success of channel decoder 510 (FIG. 5) before the channel decoder starts to decode the received RV block. The inputs to the predictor block 702 may be the TRS and the RSs associated with the TB. The output of the predictor block 702 and TRS computation block 700 is input to a combiner 704 for final prediction decision, giving a binary output, for example, 1 meaning decoder success prediction, 0 meaning failure prediction.

The decoder success predictor 702 may be trained using a supervised learning technique using known sequences of RS and/or RS related measurements (e.g., CSI-RSRP, CSI-RSRQ, CSI-SINR) inputs and corresponding decoder outputs.

Relative to eACK/eNACK feedback generation and transmission, the output of the Channel Decoder Success Predictor 702 is used to generate eACK/eNACK feedback. The eACK/eNACK feedback may include a binary field to denote the prediction of the success or failure of the decoder. The eACK/eNACK feedback also includes the TRS depending on the reference signals that are associated with the TB. The TRS may consist or be comprised of a flexible number of bits, m. For example, if TRS of m=4 bits, then 2^{m}=2⁴=16 level transmission reliability score may be generated. For example, for m=4, level 16 may represent the best channel condition and level 1 may represent the worst channel condition.

In an option, the eACK/eNACK feedback may only include the TRS. In this case, TX may decide on retransmission based on the reliability score.

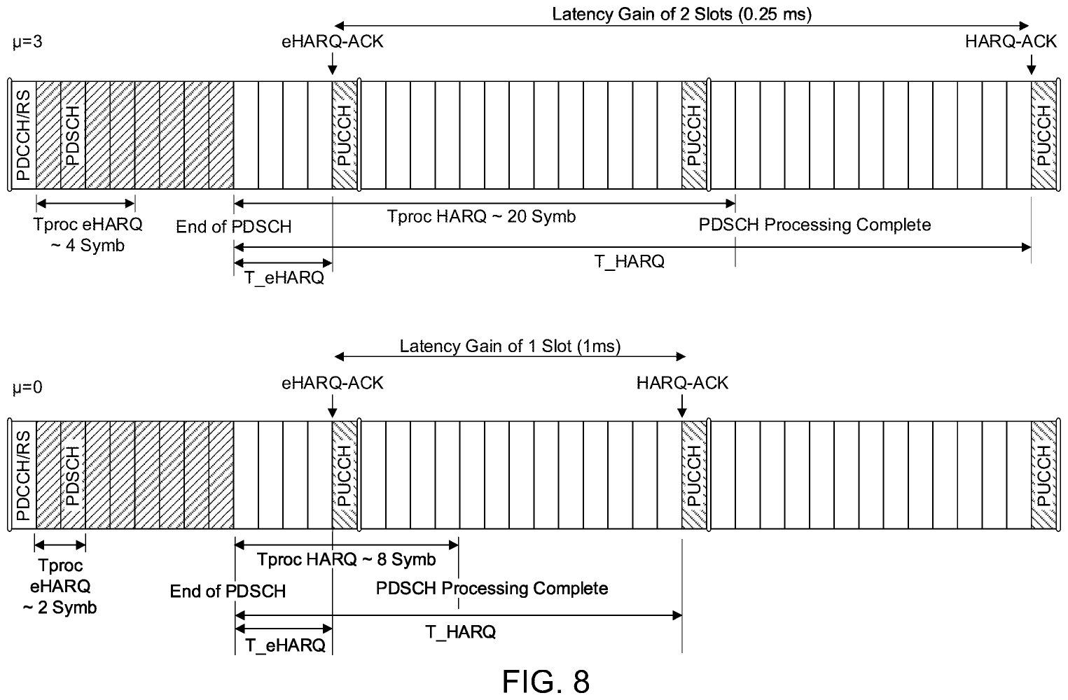

FIG. 8 is a diagram illustrating a latency gain with E-HARQ, according to an embodiment.

Potential latency gain with E-HARQ is illustrated in FIG. 8 where two different subcarrier spacings μ=0, 3 (15 KHz, 120 KHz) are used. In case of μ=3, the PDSCH processing time (Tproc HARQ) at the WTRU 502 (FIG. 5) after the full reception of PDSCH is around 20 symbols according to the standards (TS 38.214 Table 6.4-1). Assuming the PDSCH transmission was on the k^{th} slot, the HARQ-ACK message may be sent using the PUCCH in slot k+2. The total time to send the HARQ-ACK (T_HARQ) message becomes 32 symbols. The processing of eHARQ-ACK starts after the reception of Reference signals. Assuming that 4 symbols are sufficient to compute eHARQ-ACK message, eHARQ-ACK message may be sent within the same slot over PUCCH. The total time to send the HARQ-ACK (T_HARQ) message becomes 4 symbols. In case of μ=3, a latency gain of 2 slots (0.25 ms) is achieved.

In case of μ=0, a latency gain of 1 slot (1 ms) may be achieved based on the PDSCH processing time of 8 slots (TS 38.214 Table 6.4-1) and assuming eHARQ-ACK processing time of 2 slots.

The eACK/eNACK feedback may be sent over PUCCH as a new UCI message. The new UCI content may include eACK/eNACK or TRS as eACK/eNACK. Only eACK/eNACK is of size 1 bit for each TB. TRS as eACK/eNACK may consist or may be comprised of multiple bits. For example 4 bits long TRS content representing 16 level TRS feedback to BS 508 (FIG. 5).

A received RV block size may be determined. As the WTRU 502 (FIG. 5) receives a retransmission RV block, the WTRU may need to know the size of RV block. In one option, the WTRU 502 acquires the retransmission RV block size information from the related TRS that was fed back to the BS 508 (FIG. 5). In this embodiment, the WTRU 502 may map the TRS to WTRU using a look-up table that also exists at the BS. In another embodiment, the WTRU 502 may receive the RV block size information within a PDCCH message prior to the RV block transmission in the specific slot.

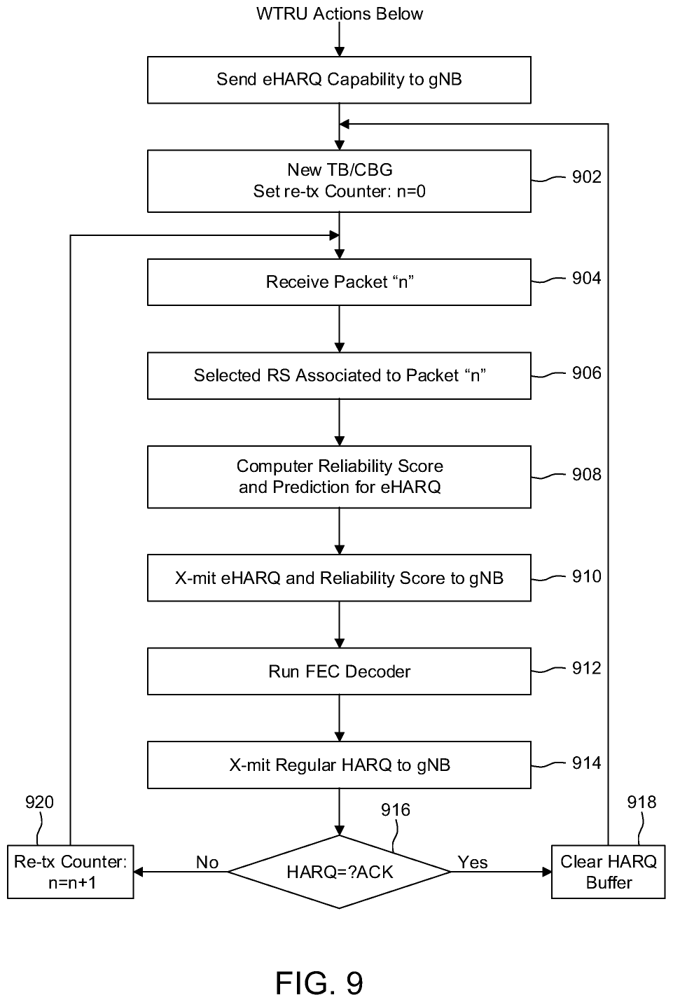

FIG. 9 is a flowchart illustrating E-HARQ operation at a wireless transmit/receive unit (WTRU) 502 (FIG. 5), according to an embodiment.

A WTRU 502 (FIG. 5) may perform early HARQ prediction and TRS computation operations. FIG. 9 illustrates a flowchart as described herein. A WTRU 502 may perform the following operation steps. At a step 902, the E-HARQ process starts for a new transport block at the WTRU 502, and the retransmission counter n is set to 0. At a step 904, the WTRU 502 receives packet #n for the current TB from BS 508 (FIG. 5). If this transmission is a retransmission, the WTRU 502 receives the RV index (which may indicate the number of parity bits and/or the puncturing pattern in the re-transmission). In one embodiment, the WTRU 502 may receive the adaptive RV index from the BS 508, e.g. in the DCI. Alternately, the WTRU 502 may determine the adaptive RV index e.g. based on the TRS of the previous transmission of the same transport block.

At a step 906, the WTRU 502 selects the RS associated with the received RV block #n. Based on the selected RS, at a step 908 the WTRU 502 computes the TRS and predicts decoder success. At a step 910, the WTRU 502 sends TRS and/or eACK/eNACK feedback to the BS 508 based on the prediction. At a step 912, the WTRU 502 completes FEC decoding.

In case the CRC check passes at a step 916 after decoding at a step 914, the WTRU 502 (FIG. 5) sends an ACK to the BS 508 (FIG. 5), at a step 918 discards the packet #n+1 upon its arrival, at the step 902 sets the re-tx counter to 0 and moves to the processing of next TB at the step 904. In case CRC check fails at the step 916 after decoding, the WTRU 502 sends NACK to the BS, increments the re-tx counter by one at a step 920, and waits for the packet #n+1 from BS at the step 904.

There can be systems and methods to choose between Early HARQ and regular HARQ mechanisms based on observed performance of the Early HARQ mechanism over a time period. The WTRU 502 (FIG. 5) may be configured by a BS 508 to use both E-HARQ and HARQ mechanisms simultaneously for the first given number of transport blocks with the new HARQ type field in the DCI that indicates the HARQ type options such as both E-HARQ and HARQ, only E-HARQ or only HARQ.

The WTRU (FIG. 5) continuously measures the accuracy of the Early HARQ mechanism by computing the consistency of eACK/eNACK and ACK/NACK messages over the observed time period. In case of explicit signaling, the WTRU 502 may send E-HARQ accuracy feedback to the BS 508 (FIG. 5). The WTRU 502 receives instructions from the BS 508 to use only E-HARQ/E-HARQ followed by HARQ/only HARQ for a given number of transport blocks, if BS decides that E-HARQ accuracy is high/medium/low.

In case of implicit signaling, the WTRU 502 (FIG. 5) and BS 508 (FIG. 5) may determine the HARQ type based on the E-HARQ and HARQ feedback messages and active HARQ type. In an embodiment, methods and procedures that enable switching between E-HARQ and regular HARQ mechanisms based on the accuracy of predictions within the E-HARQ mechanism are proposed.

The WTRU 502 (FIG. 5) receives the type of HARQ mechanism to use for a specified period of time from the BS 508 (FIG. 5). The WTRU may receive this instruction, HARQ type, as a new field in the DCI. As an example, the new HARQ type field may be included in the DCI with the following new field: HARQ_feedback type indicator (Bits: 2 bits) which indicates the type of HARQ to use; only E-HARQ, both E-HARQ and HARQ, only HARQ.

A computation of the E-HARQ prediction accuracy may be made. The Early-HARQ (E-HARQ) mechanism uses a predictor to predict the decoding success/failure of the channel decoder and create the feedback eACK/eNACK accordingly. The decoding success/failure of the channel decoder determines the type of regular HARQ feedback, i.e., ACK or NACK.

An explicit computation may be made. The prediction accuracy may be computed as the correct number of eACK/eNACK predictions divided by the total number of predictions, i.e., the total number of code block reception at the WTRU in the case where prediction is applied to each code block.

An implicit computation may be made. The implicit computation of E-HARQ accuracy at the BS 508 (FIG. 5) and the WTRU 502 (FIG. 5) depends on the active HARQ type in use. In case of only E-HARQ, the WTRU 502 may only send eACK/eNACK feedback to the BS 508. This feedback is created based on the decoder success prediction for code blocks. The WTRU 502 does not send any feedback to the BS 508 if the decoding actually fails or succeeds. Hence, the BS 508 is not aware of the channel decoder outcome. However, if any of the code blocks cannot be successfully decoded, then the transport block (TB) CRC will fail, and the entire TB will have to be retransmitted. It may be assumed that the WTRU 502 always requests the retransmission of TB from BS 508 in case TB-CRC fails. Hence, in case of only E-HARQ, retransmission of TB may be used as a measure of prediction accuracy. As an example, if a TB must be retransmitted despite all eACKs for code block groups, then the BS 508 and the WTRU 502 may switch to both E-HARQ and HARQ state.

In case of both E-HARQ and HARQ, the WTRU 502 (FIG. 5) sends both eACK/eNACK and ACK/NACK feedback to the BS 508 (FIG. 5). Hence, the BS is aware of both prediction outcome and actual channel decoder outcome. The prediction accuracy may be computed as the correct number of eACK/eNACK predictions divided by the total number of predictions.

In case of only HARQ, the WTRU 502 (FIG. 5) only sends HARQ feedback to BS 508 (FIG. 5). Hence, BS 508 is not aware of the predictor outcome at the WTRU 502. If the current HARQ type is “only HARQ”, after a predefined timeout, the BS 508 and the WTRU 502 may switch to both E-HARQ and HARQ.

E-HARQ accuracy feedback may be provided explicitly or implicitly. Using explicit signalling, the WTRU 502 (FIG. 5) feedbacks the E-HARQ accuracy feedback to BS 508 (FIG. 5) for the BS to select the HARQ type. As an example, the E-HARQ accuracy feedback may be defined as a new field in the UCI with 3 bits that may represent 8 levels of accuracy. Higher or lower number of levels may be used to determine the precision of accuracy feedback.

Using implicit signalling, prediction accuracy feedback is not sent from the WTRU 502 (FIG. 5) to the BS 508 (FIG. 5). Instead, the BS 508 and the WTRU 502 determine the HARQ type based on E-HARQ and HARQ feedback messages.

HARQ type selection may be explicit or implicit. In case of explicit signalling, the WTRU 502 (FIG. 5) sends the E-HARQ prediction accuracy to BS 508 (FIG. 5). Then, the BS 508 decides the HARQ type based on the computed accuracy. Initial HARQ type is both E-HARQ and HARQ. If the accuracy is below a predefined threshold, i.e., Thr_low, then the BS 508 selects only HARQ. Else if, the accuracy is above a predefined threshold, i.e., Thr_high, then the BS 508 selects only E-HARQ. Else, the BS 508 selects the type both E-HARQ and HARQ.

In the implicit case, a WTRU 502 (FIG. 5) does not send the prediction accuracy feedback to the BS 508 (FIG. 5). Initial HARQ type is both E-HARQ and HARQ.

Active State: both E-HARQ and HARQ. If the accuracy is below a predefined threshold, i.e., Thr_low, then HARQ type is switched to only HARQ. If the accuracy is above a predefined threshold, i.e., Thr_low, then HARQ type is switched only E-HARQ. Active State: Only HARQ. If a predefined timeout is reached, then HARQ type is switched to both E-HARQ and HARQ. Active State: Only E-HARQ. If a TB must be retransmitted despite all eACKs for code block groups, then HARQ type is switched to both E-HARQ and HARQ.

The processing of early HARQ feedback and generation of a dynamic RV block may be based on the transmission reliability score (TRS). Systems and methods for processing Early HARQ ACK/NACK feedback and generating dynamic RV block accordingly at the BS 508 (FIG. 5) including steps where: A BS receives E-HARQ capability from the WTRU 502 (FIG. 5); a BS starts the transmission of a transport/code block and transmitting first encoded code block (RV block) to the WTRU; a BS receives an eACK/eNACK message and/or Transmission Relibility Score (TRS) for the transmitted RV block; a BS determines the size of a next RV block based on the TRS and preparing the RV block.

In case the BS 508 (FIG. 5) receives an eNACK, the BS transmits the next RV block to the WTRU 502 (FIG. 5). If the BS 508 receives an ACK for the previous RV block, the BS moves to the processing of next transport/code block. If the BS 508 receives a NACK, the BS waits for the eACK/eNACK for the last transmitted RV block.

In case the BS 508 (FIG. 5) receives an eACK, the BS waits for ACK/NACK for the last transmitted RV block. If the BS 508 receives a NACK, the BS transmits the prepared RV block to the WTRU 502 (FIG. 5). If the BS 508 receives an ACK, the BS moves to the processing of next transport/code block.

In an embodiment, methods and procedures that enable Early HARQ (E-HARQ) mechanism at a BS 508 (FIG. 5) for future wireless systems is proposed. The E-HARQ mechanism is comprised of processing eACK/eNACK feedback messages and generating RV blocks based on TRS.

FIG. 5 illustrates new and modified blocks for the proposed methods on the PHY layer architecture. At the BS 508, generation of RV blocks based on TRS is processed within the E-HARQ-IR block.

RV block generation may be performed based on TRS. The BS 508 receives eACK/eNACK feedback from the WTRU 502 at a E-HARQ/IR block 512 together with the TRS and decides on the size of new retransmission packet (adaptive RV block) to be sent as part of retransmission to the WTRU. If the TRS is low, then a longer retransmission packet may be sent to compensate for the bad channel status. If the TRS is high, then a smaller retransmission packet may be sent. For example, for a 16 level reliability score, level 16 may correspond to the smallest parity packet to be sent, and level 1 may correspond to the longest parity packet to be sent. An example parity packet length lookup table for m=4 is given in Table 2, where P1>P2> . . . >P16.

TABLE 2
Retransmission Packet Size

| RS | Re-tx Packet Size |
|---|---|
| 1 | P1 |
| 2 | P2 |
| . . . | . . . |
| 16 | P16 |

In one option, the BS 508 and the WTRU 502 may use a look-up table based on TRS to determine the size of retransmission RV block. In another option, the BS 508 may send the RV index (i.e., RV size information) to the WTRU 502 within the DCI in PDCCH prior to the RV block.

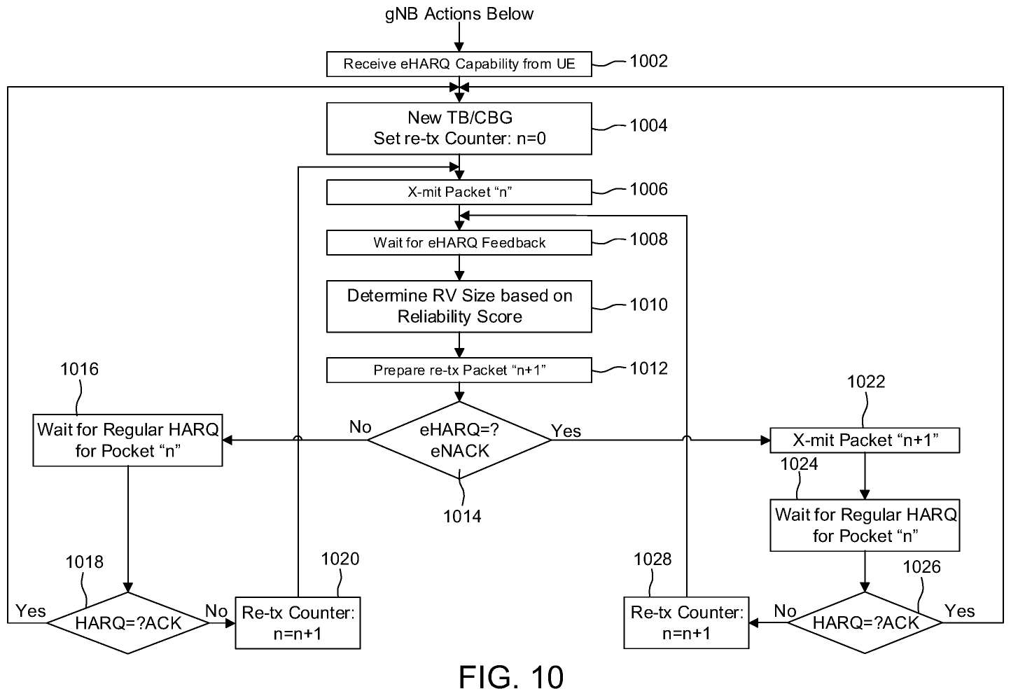

Early HARQ Processing and Adaptive RV block Generation may be performed at the BS 508. The flowchart for the proposed methods at the BS is provided in FIG. 10. The flowchart is explained below.

The following operation steps may be performed at the BS 508 (FIG. 5). At a step 1002, the BS 508 receives an indication of whether the WTRU 502 (FIG. 5) has eHARQ capability. At a step 1004, the E-HARQ process starts for a new transport block at the BS 508, and the retransmission counter n is set to 0. At a step 1006, the BS 508 sends the packet #n for the current TB to the WTRU 502, and at a step 1008 waits for eHARQ feedback. At a step 1010, based on the received TRS, the BS 508 determines the size of next RV packet and, at a step 1012, prepares the next RV block for retransmission.

At a step 1014, in case the BS 508 (FIG. 5) receives eACK, then at a step 1016 the BS waits for regular HARQ feedback for packet #n. At a step 1018, in case the BS 508 receives an ACK, the BS drops the prepared retransmission RV block #n+1 and moves to processing the next TB at the step 1004. But in case, at the step 1018, the BS 508 receives a NACK, at a step 1020 the BS increments the retransmission counter by one and, at the step 1006, sends the prepared Rv block to the WTRU 502 (FIG. 5). At the step 1014, in case the BS 508 receives an eNACK, at a step 1022 the BS sends the next retransmission RV block #n+1 to the WTRU 502. At a step 1024, the BS 508 waits for the regular HARQ feedback for packet #n. At a step 1026, in case the BS 508 receives an ACK, the BS moves to processing the next TB at the step 1004. But in case the BS 508 receives a NACK at the step 1026, at a step 1028 the BS increments the retransmission counter by one and, at the step 1008, waits for the next eACK/eNACK feedback for packet #n+1.

HARQ may be optimized dynamically. The WTRU 502 (FIG. 5) computes and feeds back a long-term reliability score. This may be reported less frequently, for example, this score could be reported similar to or simultaneously with CSI Report (could be periodic or non-periodic). This score may be averaged, highest/lowest value since last report, etc. The WTRU 502 receives a transport block using an initial Redundancy Version based on the long-term reliability score reported by the WTRU. There may be many possible RVs. Upon decoding failure/prediction, the WTRU 502 sends a short-term reliability score. The short-term reliability score determines the RV used for re-transmission. In an embodiment, dynamically reconfiguring the code-block grouping based on the received short-term reliability score may be performed. Efficient compression methods may be used.

The WTRU 502 (FIG. 5) may assist in the HARQ re-transmissions by reporting both long-term and short-term metrics to indicate its prediction of channel decoding success, and thereby assist in the adjustment of re-transmission parameters, e.g., RV number.

The WTRU 502 (FIG. 5) may calculate the prediction of decoding success of each individual TB, i.e., a short-term TRS, which is referred to herein simply as TRS. The short-term TRS may be calculated using one of multiple methods including estimate of the channel estimation quality based on DMRS, estimate of CSI estimation quality based on the CSI-RS, decoding convergence rate, etc.

The WTRU 502 (FIG. 5) may be capable of supporting more than one method of estimating the short-term TRS. The WTRU 502 may indicate to the gNB (BS) 508 (FIG. 5) all the supported methods for calculating the short-term TRS in the WTRU capability information.

The WTRU 502 (FIG. 5) may be configured by the gNB (BS) 508 (FIG. 5) to calculate the short-term TRS. This configuration may be included in one of either RRC signaling, DCI or MAC-CE indication. The configuration may include one or more of the following, including: an indication to use one of the available methods to calculate short-term TRS, number of bits used to report the short-term TRS, time-frequency resource allocation for sending the short-term TRS report, if it is not explicitly included in the DCI used to schedule the TB in the PDSCH, etc.

The WTRU 502 (FIG. 5) may also calculate a long-term metric representing the long-term prediction of channel decoding success to the gNB 508 (FIG. 5). This metric, for example, a long-term TRS may represent the success of decoding a TB in a long-term sense and may represent the effects of slow changes in the channel.

The long-term TRS may be calculated as a function of the individual short-term TRS values calculated over a duration of time, e.g., a configured duration, the duration between successive reporting instances of the long-term TRS, etc. The function used to calculate the long-term TRS may be one of average, weighted average, median, maximum, minimum, etc.

The WTRU 502 (FIG. 5) may be configured by the gNB 508 (FIG. 5) to calculate the long-term TRS. This configuration may be included in one of either RRC signaling, DCI, or MAC-CE indication. The configuration may include one or more of the following: an indication to use one of the available methods to calculate short-term TRS, number of bits used to report the short-term TRS, periodicity of generating the long-term TRS report, time duration over which short-term TRS values are considered for the calculation of long-term TRS, etc.

The WTRU 502 (FIG. 5) may be configured to report the long-term TRS either periodically, semi-statically, or aperiodically.

The WTRU 502 (FIG. 5) may be configured with a method to transmit the long-term TRS report to the gNB 508 (FIG. 5). This may include one of: transmitting the long-term TRS report on its own, including the long-term TRS report as part of the CSI report, etc.

The WTRU 502 (FIG. 5) may calculate the short-term TRS for the received TB, and if the calculated value indicates that the TB decoding will likely fail, then the WTRU may send the short-term TRS report in the indicated time-frequency resources. If the calculated short-term TRS value indicates that the TB decoding may likely succeed, then the WTRU 502 may either transmit the short-term TRS report to inform the gNB 508 (FIG. 5) about its assessment or skip the short-term TRS transmission. The lack of short-term TRS report from the WTRU 502 or a short-term TRS report that indicates high likelihood of decoding success may inform the gNB 508 to move the next TB, without any re-transmission for the current TB.

The number of bits used for the short-term TRS may indicate simply an ACK/NACK value in case of a single bit or may indicate the WTRU's estimated likelihood of the decoding success, when multiple bits are available for the short-term TRS report.

The WTRU 502 (FIG. 5) may be configured to update the long-term TRS value when the calculated short-term TRS for a TB indicates likely decoding failure. The new long-term TRS value may be calculated in one of the following ways including replacing the old long-term TRS value with the newly calculated short-term TRS value, determining the new long-term TRS value as a function of the long-term TRS value and the newly calculated short-term TRS value, etc. The reporting of the new long-term TRS value may be either implicit or explicit. In one option the WTRU 502 may explicitly signal the new long-term TRS value. In another option the new long-term TRS value is implicitly known at the gNB 508 (FIG. 5), based on the old long-term TRS report and the new short-term TRS report.

The WTRU 502 (FIG. 5) may be configured to choose the method to calculate the new long-term TRS value, based on the number of short-term TRS values indicating likely decoding failure since the last long-term TRS report transmission. For example, for the first short-term TRS value that indicates a likely decoding failure the WTRU 502 may be configured to calculate the new long-term TRS value using a function of the old long-term TRS value and the newly calculated short-term TRS value. In the same example, for N instances of short-term TRS value indicating a likely decoding failure condition since the last long-term TRS report transmission, the WTRU 502 may be configured to replace the old long-term TRS value with the newly calculated short-term TRS value.

The above described embodiments sometimes require additional control signaling to enable E-HARQ and HARQ joint operation. In some embodiments, E-HARQ capability signaling may be required. If the WTRU 502 (FIG. 5) has E-HARQ capability, the WTRU indicates its capability as a new field in the MAC parameters or physical layer parameters of WTRU radio access capability parameters. As an example, a new Early HARQ capability field may be included as the following new field:

| | | | FDD − | FR1 − |
|---|---|---|---|---|
| | | | TDD | FR2 |
| Definitions for parameters | Per | M | DIFF | DIFF |
| EarlyHARQ-ACK | UE | — | No | No |
| Indicates whether UE supports Early HARQ | | | | |
| ACK/NACK feedback message. (1 bit) | | | | |

In some embodiments, an E-HARQ Timing Indicator is received by the WTRU 502 (FIG. 5) from the BS 508 (FIG. 5) to its E-HARQ ACK/NACK feedback transmission in addition to regular HARQ ACK/NACK. The WTRU 502 may receive the new timing indicator for E-HARQ in the downlink control information (DCI) (Format 1_0 or 1_1). As an example, the new DCI field can be included as the following field:
PDSCH-to-EHARQ_feedback timing indicator
   which Indicates the number of slots between PDSCH reception and E-HARQ transmission.

The number of time slots between PDSCH reception and E-HARQ transmission indicated by the E-HARQ timing indicator values may be less than that of the HARQ timing indicator to ensure that E-HARQ feedback is scheduled at least one slot before the regular HARQ feedback. As an example, the PDSCH-to-EHARQ_feedback timing indicator field values map to lower values than {1, 2, 3, 4, 5, 6, 7, 8} for SCS configuration of PUCCH transmission μ≤3, to lower values than {7, 8, 12, 16, 20, 24, 28, 32} for μ=5, and to lower values than {13, 16, 24, 32, 40, 48, 56, 64} for μ=6.

In some embodiments, the eACK/eNACK may be sent over a PUCCH as a new UCI message. The new UCI content may include eACK/eNACK or TRS.

A WTRU 502 (FIG. 5) may be allocated a first set of resources for regular HARQ and CSI reporting. The WTRU 502 may be allocated with a second set of resources for E-HARQ and/or TRS feedback reporting. For example, in the second set of resources, the eACK/eNACK field is of size 1 bit for each TB. TRS may consist of multiple bits. For example, 4 bits long TRS content representing 16 level TRS feedback to BS. The TRS may consist of a flexible number of bits, m. For example, if TRS of m=4 bits, then 2^{A}m=2^{A}4=16 level transmission reliability score can be generated. For example, for m=4, level 16 may represent the best channel condition and level 1 may represent the worst channel condition.

The eACK/eNACK and TRS fields can be feedback from the WTRU 502 (FIG. 5) to the BS 508 (FIG. 5) using UCI signaling using the second set of resources. The UCI signaling originally carries HARQ-ACK, SR, and CSI information using the first set of resources.

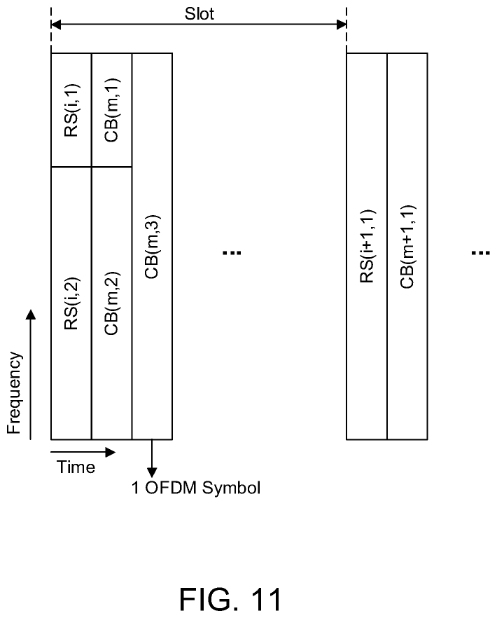

In some embodiments, RS to CB associations may exist for High Frequency/Bandwidth Scenarios. For scenarios with high frequency high bandwidth and high SCS, one OFDM symbol may carry more than one code block (CB). In such scenarios, the association of reference signals (RS) to code blocks (CB) is defined based on the start and end of the associated resource blocks in frequency. An example code block allocation is given in FIG. 11. An example RS to CB association is given below in Table 3.

TABLE 3
RS to CB Association

| CB | Selected RS |
|---|---|
| CB(m, 1) | RS(i, 1) |
| CB(m, 2) | RS(i, 2) |
| CB(m, 3) | RS(i, 1), RS(i, 2) |
| CB(m + 1, 1) | RS(i + 1, 1) |

Although the features and elements of the disclosed subject matter are described in embodiments in particular combinations, each feature or element may be used alone without the other features and elements of the embodiments or in various combinations with or without other features and elements of the disclosed subject matter.

Although embodiments described herein consider New Radio (NR), 5G or LTE, LTE-A specific, tera bit or tera Hz communication protocols, it is understood that embodiments described herein are not restricted to this scenario and are applicable to other wireless systems as well.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method performed by a wireless transmit/receive unit (WTRU), the method comprising:
transmitting, to a base station, an indication of an early hybrid automatic repeat request (E-HARQ) capability;
receiving, from the base station, an E-HARQ timing indicator, an encoded code block of a transport block (TB), and a reference symbol (RS); and
transmitting, to the base station, an indication of a transmission reliability score (TRS), wherein the TRS is based on the RS and is transmitted based on a prediction of successfully decoding the encoded code block, and wherein the TRS is transmitted on uplink resources indicated by the E-HARQ timing indicator.

22. The method of claim 21, wherein the encoded code block comprises a redundancy version (RV) block.

23. The method of claim 21, further comprising transmitting an early-acknowledge (ACK) signal or early negative acknowledgement (NACK) signal to the base station based on the prediction.

24. The method of claim 23, wherein the early ACK or early NACK signal includes the TRS.

25. The method of claim 21, wherein the TRS is based on a measure of channel distortion.

26. The method of claim 21, further comprising transmitting an indication of E-HARQ accuracy to the base station.

27. The method of claim 21, further comprising receiving an indication of a HARQ type from the base station, wherein the HARQ type includes HARQ, E-HARQ, or both HARQ and E-HARQ.

28. The method of claim 27, wherein the indication of the HARQ type is received in a downlink control information (DCI).

29. A wireless transmit/receive unit (WTRU) comprising:
circuitry configured to transmit, to a base station, an indication of an early hybrid automatic repeat request (E-HARQ) capability;
circuitry configured to receive, from the base station, an E-HARQ timing indicator, an encoded code block of a transport block (TB), and a reference symbol (RS); and
circuitry configured to transmit, to the base station, an indication of a transmission reliability score (TRS), wherein the TRS is based on the RS and is transmitted based on a prediction of successfully decoding the encoded code block, and wherein the TRS is transmitted on uplink resources indicated by the E-HARQ timing indicator.

30. The WTRU of claim 29, wherein the encoded code block comprises a redundancy version (RV) block.

31. The WTRU of claim 29, further comprising transmitting an early-acknowledge (ACK) signal or early negative acknowledgement (NACK) signal to the base station based on the prediction.

32. The WTRU of claim 31, wherein the early ACK or early NACK signal includes the TRS.

33. The WTRU of claim 29, wherein the TRS is based on a measure of channel distortion.

34. The WTRU of claim 29, further comprising transmitting an indication of E-HARQ accuracy to the base station.

35. The WTRU of claim 29, further comprising receiving an indication of a HARQ type from the base station, wherein the HARQ type includes HARQ, E-HARQ, or both HARQ and E-HARQ.

36. The WTRU of claim 35, wherein the indication of the HARQ type is received in a downlink control information (DCI).

37. A method performed by a base station the method comprising:
receiving, from a wireless transmit/receive unit (WTRU), an indication of an early hybrid automatic repeat request (E-HARQ) capability;
transmitting, to the WTRU, an E-HARQ timing indicator, an encoded code block of a transport block (TB), and a reference symbol (RS); and
receiving, from the WTRU, an indication of a transmission reliability score (TRS), wherein the TRS is based on the RS, and wherein the TRS is received on uplink resources indicated by the E-HARQ timing indicator.

38. The method of claim 37, wherein the encoded code block comprises a redundancy version (RV) block.

39. The method of claim 37, further comprising receiving an early-acknowledgement (ACK) signal or an early negative-acknowledgement (NACK) signal from the WTRU.

40. The method of claim 39, wherein the early ACK signal or early NACK signal includes the TRS.
